(19) United States
(12) Patent Application Publication
(10) Pub. No.: US 2020/0193231 A1
(43) Pub. Date: Jun. 18, 2020

(54) Training Model Generation

(71) Applicant: International Business Machines Corporation, Armonk, NY (US)

(72) Inventors: Chao Xue, Beijing (CN); Rong Yan, Beijing (CN); Yonghua Lin, Beijing (CN); Yonggang Hu, Richmond Hill (CA)

(21) Appl. No.: 16/221,914

(22) Filed: Dec. 17, 2018

(51) Int. Cl. G06K 9/62; G06N 20/00

(52) U.S. Cl. CPC G06K 9/6257; G06K 9/6262; G06K 9/6215; G06N 20/00

(57) ABSTRACT

Embodiments of embodiments of the present invention relate to generation of a training model using virtual dataset and probe training models. A computer-implemented method comprises: receiving, by a device operatively coupled to one or more processors, a user dataset for training; testing, by the device, the user dataset with one or more probe training models; and in response to a result of the testing being similar to an existing result of running the one or more probe training models on an existing virtual dataset, grouping, by the device, the user dataset with the existing virtual dataset.

### BACKGROUND

The present invention relates to generation of training models in machine learning, and more specifically, to generation of a training model using virtual dataset and probe training models.

### SUMMARY

With fast growth of artificial intelligence (AI) technology that is applied in variety of industries, data analytics becomes more and more important. A key area in AI technology is deep learning/machine learning to analyze huge amounts of datasets to provide insight through neural network such as convolutional neural network (CNN) and recurrent neural network (RNN), etc. Recently, automatic machine learning (Auto ML) has become a hot topic as well. Auto ML is used to automatically generate a training model for datasets to implement data training works. In the past, the training model requires manual design and adjustment that will take significant time cost of data experts.

According to one embodiment of the present invention, there is provided a method facilitating generation of a training model using virtual dataset and probe training models. The computer-implemented method comprises: receiving, by a device operatively coupled to one or more processors, a user dataset for training; testing, by the device, the user dataset with one or more probe training models; and in response to a result of the testing being similar to an existing result of running the one or more probe training models on an existing virtual dataset, grouping, by the device, the user dataset with the existing virtual dataset.

According to another embodiment of the present invention, there is provided a system facilitating generation of a data training model. The system comprises: a memory that stores computer executable components; and a processor that executes the computer executable components stored in the memory. The computer executable components comprise at least one computer-executable component that: receives a user dataset for training; tests the user dataset with one or more probe training models; and in response that a result of the testing being similar to an existing result of running the one or more probe training models on an existing virtual dataset, groups the user dataset with the existing virtual dataset.

According to yet another embodiment of the present invention, there is provided a computer program product facilitating generation of a training model using virtual dataset and probe training models. The computer program product comprises a computer readable storage medium having program instructions embodied therewith, the program instructions executable by a processor to cause the processor to: receive a user dataset for training; test the user dataset with one or more probe training models; and in response to a result of the testing being similar to an existing result of running the one or more probe training models on an existing virtual dataset, group the user dataset with the existing virtual dataset.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to embodiments of the present invention;

FIG. 2 depicts a cloud computing environment according to embodiments of the present invention;

FIG. 3 depicts abstraction model layers according to embodiments of the present invention;

FIG. 4 briefly shows basic architecture of the key idea of embodiments of the present invention;

FIG. 5A is a flow chart that shows a method facilitating generation of a training model according to an embodiment under the present invention;

FIG. 5B is a flow chart that shows a method facilitating generation of a training model according to another embodiment under the present invention;

FIG. 6A briefly shows exemplary of probe models that are used to test the user dataset according to embodiments of the present invention;

FIG. 6B briefly shows exemplary of training models that has been applied to the existing virtual dataset according to embodiments of the present invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

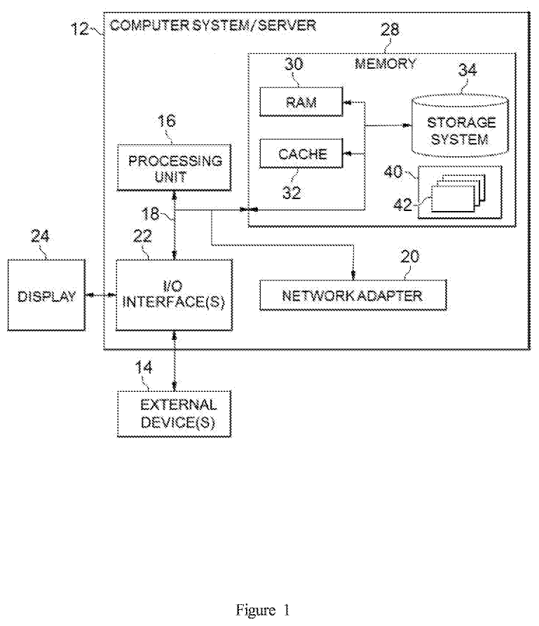

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

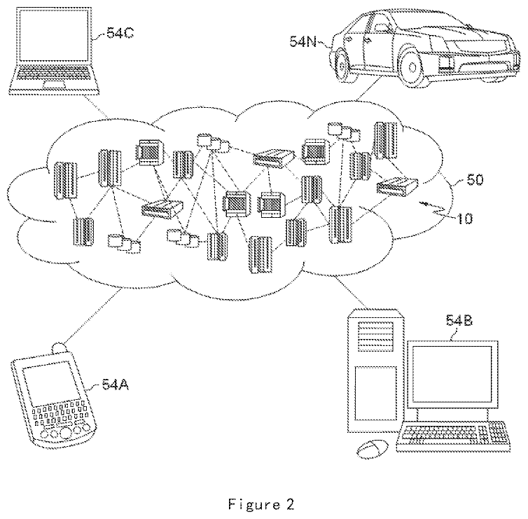

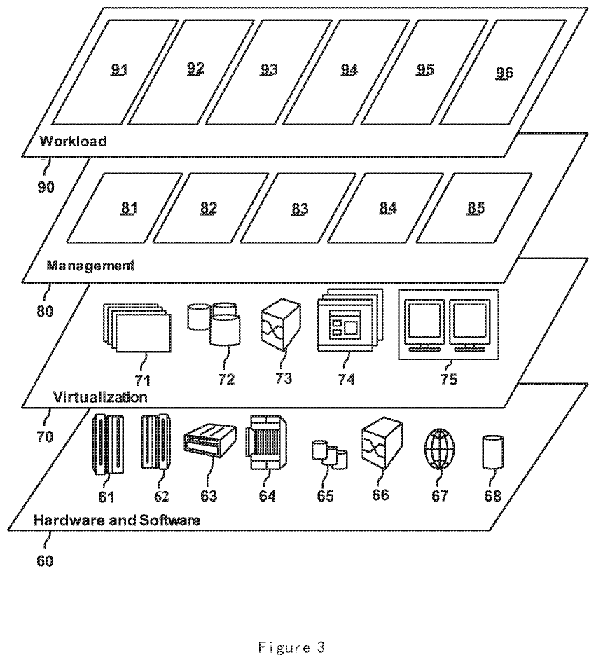

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and training model generation 96.

Hereinafter in the present disclosure, “training model” or “model” means a neural network architecture and hyperparameters. In machine learning domain, how to generate a proper neural network (training model) to train the datasets is a key issue. Auto Machine Learning (AutoML) is a process of automating an end-to-end process of applying machine learning to real-world problems. In a typical machine learning application, the training model, which can also be referred to neural network structure, has to be designed and adjusted by the practitioners to accommodate to different types of datasets. Such design and adjustment work can take significant time of practitioners. AutoML can be used to automate this training model design process, thus saving practitioners' time effort significantly.

Currently there are several existing algorithms of AutoML, such as Genetic Algorithm, Grid Search, Bayesian Optimization, Reinforcement Learning and so on. However, these existing AutoML solutions are all very time consuming. For example, according to Reinforcement Learning solution, different neural network architectures can be tested one by one until a best architecture can be found out for certain datasets. Such testing process takes long time and efforts of computation. Therefore, there is a need to provide a solution to leverage the AutoML's benefits of automatic generation of training models for datasets, i.e. the neural network architectures, while at the same time balancing the time cost of AutoML process.

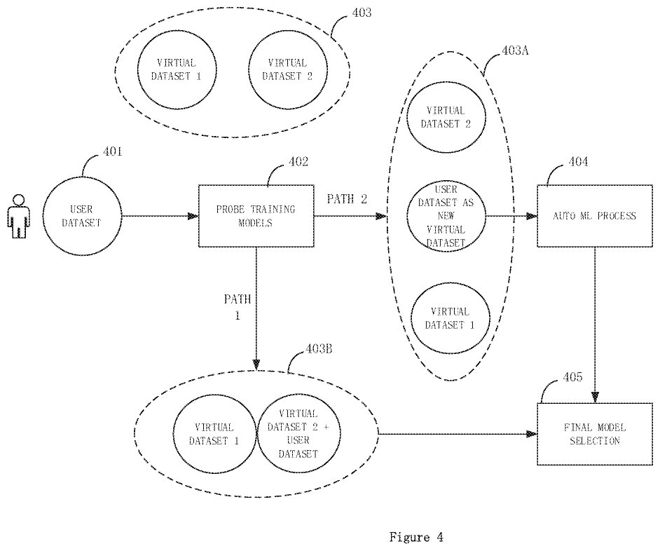

Now key ideas of embodiments of the present invention can be introduced with reference to FIG. 4 that briefly shows basic architecture of the key ideas of embodiments of the present invention. As shown in FIG. 4, users can upload original datasets 401 to a probe model module 402, which contains one or more probe training models. These probe training models are not actual training models that have been applied to any dataset but only for the purpose of testing the uploaded datasets. Also, there is a virtual datasets pool 403 that contains virtual dataset 1 and virtual dataset 2 as shown in FIG. 4. A virtual dataset is a key idea of embodiments of the present invention, which contains different sub-datasets that can belong to different data categories. For example, common knowledge is that all images of cats and images of dogs can belong to two different data categories in data training process. However, virtual datasets that can contain different data belonging to different categories which are used in the present invention facilitating generation of training models.

The probe models in the probe model module 402 can be run on the uploaded dataset 401 to generate one or more testing results. Then, depending on the testing results, there are two possible following paths, path 1 and path 2 shown in FIG. 4. If a testing result satisfies criteria of similarity as compared to a result obtained by running the probe models on one or more existing virtual datasets, i.e. virtual dataset 1 and/or virtual dataset 2 in the virtual datasets pool 403, then path 1 can be selected. In path 1, the user dataset 401 can be grouped into the virtual dataset of which the result is determined to be similar to the testing result. For example, as shown in FIG. 4, in Path 1, user dataset 401 is grouped into virtual dataset 2 as shown in 403B. Then there is no need to perform AutoML process on the grouped virtual dataset to generate a training model. On the contrary, a training model that has already been applied to existing virtual dataset 2 can be directly applied to the grouped virtual dataset, i.e. virtual dataset 2+user dataset. Therefore, costs for AutoML process can be saved for Path 1.

If the testing results do not satisfy any criteria of similarity as compared to results obtained by running the probe models on the two virtual datasets, then path 2 can be selected. In Path 2 shown in FIG. 4, the user dataset can be added into the virtual dataset pool 403A as a new virtual dataset. Then, the new virtual dataset can be subject to AutoML process in 404 in order to generate a proper training model i.e. neural network structure for the new virtual dataset.

Finally, no matter whether Path 1 or Path 2 is adopted, both of the two paths can go to final model selection module 405 in order to refine the training model.

There are two major points of the ideas of embodiments of the present invention. One key point is the virtual datasets that has been mentioned above. This is important because virtual datasets focus on the data that can have common intrinsic characteristics for training model design, other than only focusing on the content or category of data. For example, a dataset of pictures of tigers is commonly understood to be better fed into the training model that has been designed for dataset of pictures of cats. However, for some of the pictures of tigers, they can be better fed into the training model that has been designed for dataset of pictures of dogs. The virtual dataset can improve accuracy and efficiency of generation of a training model for a new dataset.

Another key point of embodiments of the present invention is the probe training models shown in 402 in FIG. 4. Details about how to generate the probe training models and specific application of such probe models can be introduced below with reference to FIG. 3-4. Generally speaking, these probe training models are template architecture of neural network for testing purpose. They are used to find out which existing virtual dataset has similar characteristics with the new user dataset, and the user dataset can be grouped with the virtual dataset and the training model that has been applied to the existing virtual dataset can thus still be applied to the grouped virtual dataset.

As a result of above, Path 1 shown in FIG. 4 saves time and computation costs for those user datasets with similar existing virtual dataset. Only those user datasets without any similar existing virtual dataset (Path 2) can be subject to AutoML process to generate training models. Similarity determination can be introduced in detail hereinafter with reference to FIG. 3-4.

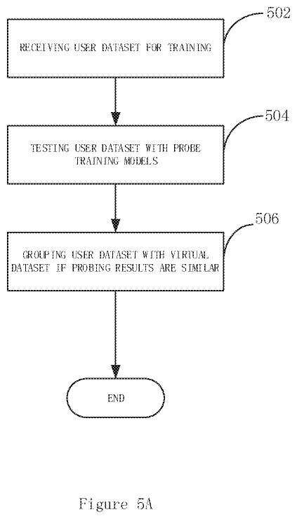

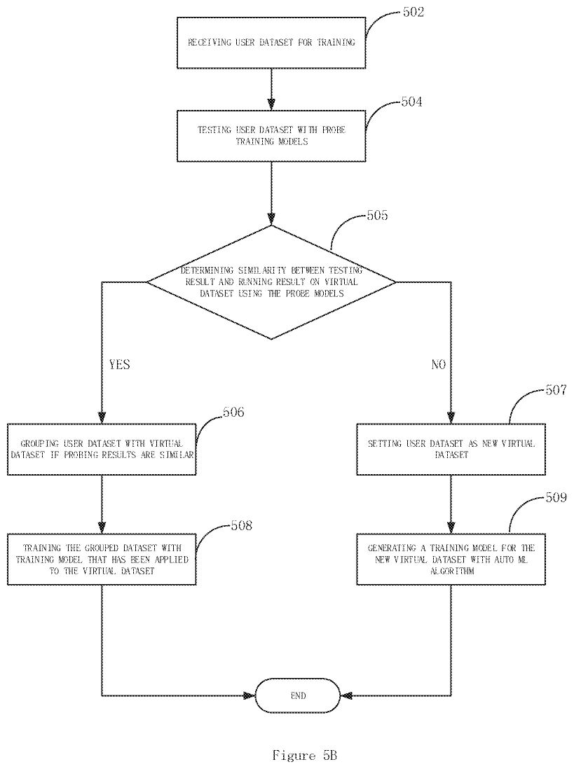

FIG. 5A is a flow chart that shows a method facilitating generation of a training model according to an embodiment under the present invention. The method shown in FIG. 5A starts from step 502. In step 502, a user dataset for training is received. A user can upload an original dataset to a server in order to generate a training model for the dataset. Under this invention, the term “training model” has the same meaning as “architecture of a neural network”. Exemplary neural network can include convolutional neural network (CNN), recurrent neural network (RNN) and so on. Persons skilled in the art should understand that the neural network is designed to train different datasets. It is an important task to find out a proper training model for specific datasets.

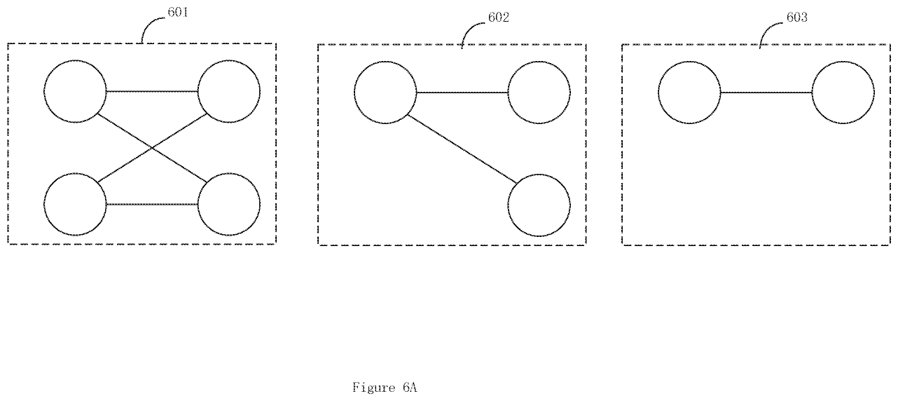

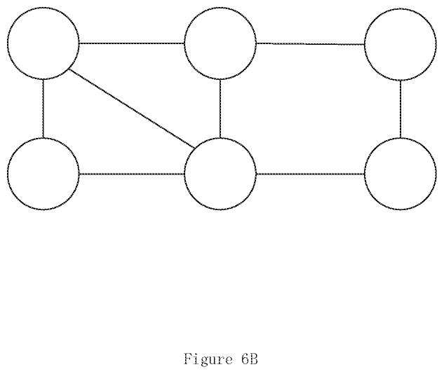

Then, the method shown in FIG. 5A moves to step 504. In step 504, the user dataset is tested with one or more probe training models. 601-603 in FIG. 6A show architectures of three probe training models. These are typical representation of architectures of neural networks. It should be understood that these probe training models are only for exemplary purpose.

According to embodiments of the present invention, the one or more probe training models are generated using an algorithm of random search (RS). RS is a mature method that should be understood by persons skilled in the art. RS is a family of numerical optimization methods that do not require the gradient of the problem to be optimized, and RS can hence be used on functions that are not continuous or differentiable. The details of RS known by persons skilled in the art will not be introduced herein.

According to another embodiment of embodiments of the present invention, the one or more probe training models are generated by domain experts through manual configuration.

It should be emphasized here that there are no mandatory or hard criteria for the probe training models because they are used to test the user dataset and also the virtual datasets. The present invention does not exert any restriction on the way in which the probe training models are generated. Supported by mathematical proofs, no matter what the probe training models are, the result of similarity determination between the testing results on the user dataset and virtual datasets can be the same.

In step 504, the testing means feeding the user dataset into each of the probe training models and get the results. For example, the testing result for a user dataset using probe training model A could be represented as vectors such as {r1A, r2A, r3A}. The testing result for a user dataset using probe training model B could be represented as vectors such as {r1B, r2B, r3B}. Here, according to embodiments of the present invention, the value of r1, r2 and r3 could be the degree of precision to utilize the probe model A on the user dataset. According to another embodiment of embodiments of the present invention, the value of r1, r2 and r3 could be the loss to utilize the probe model A on the user dataset. There is no restriction on specific meaning of the values in the vectors as results of testing the user dataset with the probe models. Persons skilled in the art can configure the meaning of values of the vectors.

It also should be emphasized that the number of values in the vectors could depend on the times that the user dataset is tested using the probe models. For example, if the user dataset is only tested once using the probe model A and B, then the vector can be {r1A} and {r1B}. If the user dataset is tested twice using the probe model A and B, then the vector can be {r1A, r2A} and {r1B, r2B} respectively. The testing times can affect the accuracy in determining the similarity in the following steps.

Then, the method shown in FIG. 5A moves to step 506. In step 506, in response that a result of the testing being similar to existing result of running the one or more probe training models on an existing virtual dataset, the user dataset is grouped with the virtual dataset.

It should be understood that a virtual dataset, as mentioned with reference to FIG. 4 above, can contain data that belongs to different data categories or with different contents. A virtual dataset is not a traditional categorization of data, but a method to categorize data based on the intrinsic data characteristics in order to group all data to which the same data training model can be applied. Under the present invention, an existing virtual dataset is also tested with the probe training models so that the result vectors have been obtained for each virtual dataset v. each probe model. For example, if there are two probe training models A and B, and there are two virtual datasets 1 and 2, then there can be four vectors to test each of the two virtual datasets using each of the probe models.

In step 506, if the testing result of the user dataset is similar to the testing result of the virtual dataset, which means the user dataset has common data characteristics to share a same data training model (architecture of neural network), then the user dataset is grouped with the virtual dataset. The determination of similarity will be further introduced hereinafter with reference with FIG. 5B.

FIG. 5B is a flow chart that shows a method facilitating generation of a training model according to another embodiment under the present invention. The method shown in FIG. 5B also starts from step 502. It could be understood that step 502 and 504 in FIG. 5B are corresponding to step 502 and 504 in FIG. 5A, so they will not be further described here.

Then, the method in FIG. 5B moves to step 505. In step 505, similarity between the result of the testing and an existing result of running the one or more probe training models on an existing virtual dataset is determined. As mentioned above, the testing result of the user dataset can be represented as a group of vectors. The existing testing result of the existing virtual dataset can also be represented as a group of vectors. So, the determination of similarity could be performed based on the comparison of the two groups of vectors as testing results.

According to embodiments of the present invention, the determination of similarity is performed based on the Euclidean distance between the two testing results i.e. two groups of vectors. According to this embodiment, after getting the testing result—vector [r1, r2, r3] of the user dataset, the vector can be compared with every existing result for the virtual dataset, and the Euclidean distance can be calculated between the vector [r1, r2, r3] and every existing result for the virtual dataset and the virtual dataset with minimal Euclidean distance can be determined. If the calculated distance is less than a threshold, then the similarity between the result of the testing and the existing result can be determined larger than a threshold, and the user dataset can be determined as similar to the virtual dataset with minimal distance.

According to another embodiment of embodiments of the present invention, the determination of similarity is performed based on the Cosine similarity between the two testing results. According to this embodiment, after getting the testing result—vector [r1, r2, r3] of the user dataset, the vector can be compared with every existing result for the virtual dataset, and the Cosine similarity can be calculated between the [r1, r2, r3] and every existing result for the virtual dataset and the virtual dataset with maximal similarity can be determined. If the calculated Cosine similarity is more than a threshold, then the user dataset can be determined as similar to the virtual dataset with maximal similarity.

According to yet another embodiment of embodiments of the present invention, the determination of similarity is preformed based on the probabilities for each of the existing results being the most similar existing result to the result of the testing. According to this embodiment, multiple vectors of testing results of the user dataset can be collected, for example, [r_11, r_12, r_13], . . . [r_n1, r_n2, r_n3], wherein the “n” refers to natural integral number representing the number of probe models. So, the distribution of the multi-dimension existing results could be estimated. For example, the likelihood, prior probabilities can be calculated, and the posterior probabilities can be obtained to decide which existing virtual dataset is most likely to be grouped with the user dataset. Also, the threshold could be decided automatically by minimize the error and searching time.

Persons skilled in the art should understand that above mentioned embodiments of determination of the similarity are only for exemplary purpose. Variety solutions and algorithms could be adopted to determine the similarity between the two testing results in step 505.

According to embodiments of the present invention, if each result of the testing on the user dataset with each of the one or more probe models is similar to each existing testing result on a virtual dataset with the same one or more probe training models, then it is determined that the user dataset is similar to the virtual dataset. For example, there are two probe models A and B, and one virtual dataset. The testing results for the user dataset with the two probe models A and B are {r1A, r2A} and {r1B, r2B} respectively. The existing testing results for the virtual dataset with the two probe models A and B are {r3A, r4A} and {r5B, r6B} respectively. It can be determined that each testing result for user dataset is similar to each testing result for virtual dataset only when {r1A, r2A} is determined as similar to {r3A, r4A}, and {r1B, r2B} also is determined as similar to {r5B, r6B}.

According to another embodiment of embodiments of the present invention, it can be determined that the testing result of the user dataset is similar to the existing testing result of the virtual dataset if some but not all of the vectors of testing results are similar with vectors of the existing testing result. For example, it can be determined that a testing result for user dataset is similar to an existing testing result for virtual dataset either when {r1A, r2A} is determined as similar to {r3A, r4A}, or {r1B, r2B} is determined as similar to {r5B, r6B}, or both.

Then, there are two branches after the determination in step 505. If it is determined in step 505 that the testing result of the user dataset is similar to the existing testing result of any of the one or more virtual dataset, then the method moves to step 506. In step 506, the user dataset is grouped with the virtual dataset whose existing testing result is determined to be similar to the testing result of the user dataset.

Then the method moves to step 508. In step 508, the grouped dataset can be directly applied with a training model that has been applied to the virtual dataset with which the user dataset is just grouped. An example of such existing training model that has been applied to the virtual dataset is shown in FIG. 6B. That is to say, there is no need to go through AutoML process for the user dataset even though it is a new dataset that was just uploaded by the user.

According to embodiments of the present invention, in step 508, if there are multiple training model applied to the virtual dataset, the best model can be selected to apply to the grouped dataset. Such model selection is existing solutions in the domain of data training and machine learning, therefore it will not be introduced herein with detail.

Now let's go back to another branch of step 505. In step 505, if it is determined that the testing result of the user dataset is not similar to any of the existing testing result of the virtual dataset, the method moves to step 507. In step 507, the user dataset is set as a new virtual dataset and is added to the virtual dataset pool.

According to embodiments of the present invention, there are one or more existing virtual datasets in the pool but none of the virtual dataset's testing result is determined as similar to the testing result of the user dataset. According to another embodiment of embodiments of the present invention, there is no virtual dataset at all. That is to say, the current user dataset can be added into the virtual dataset pool as the first virtual dataset, which means that the present invention could be implemented from scratch.

Then the method shown in FIG. 5B moves to step 509. In step 509, a training model can be generated for the newly added virtual dataset using AutoML algorithms. It should be understood that AutoML algorithms are mature algorithms in the machine learning domain and are well known to persons skilled in the art. So, it will not be introduced in detail herein.

According to embodiments of the present invention, the virtual datasets could be dynamically split and re-merged based on the dynamic change of data training models that are available in the system. For example, time intervals for conducting such inspection for splitting and re-merging could be set up beforehand. Rationale and specific method to conduct such splitting and re-merging of current virtual datasets are similar to the method in determining whether or not to add the user dataset as a new virtual dataset or group the user dataset with an existing virtual dataset.

In summary, the present invention could separate part of the user dataset to bypass the AutoML process which is very time consuming, while maintain other part of the user dataset to go through the AutoML process, through setting up virtual datasets and reusing the information across different virtual datasets by probe model testing.

It should be noted that the processing of generation of training model according to embodiments of this disclosure could be implemented by computer system/server 12 of FIG. 1.

The present invention may be a system, a method, and/or a computer program product at any possible technical detail level of integration. The computer program product may include a computer readable storage medium (or media) having computer readable program instructions thereon for causing a processor to carry out aspects of embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

Aspects of embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a device operatively coupled to one or more processors, a user dataset for training;
testing, by the device, the user dataset with one or more probe training models; and
in response to a result of the testing being similar to an existing result of running the one or more probe training models on an existing virtual dataset, grouping, by the device, the user dataset with the existing virtual dataset.

2. The computer-implemented method of claim 1, further comprising:
in response to the result of the testing not being similar to any existing result of running the one or more probe training models on the existing virtual dataset, setting, by the device, the user dataset as a new virtual dataset.

3. The computer-implemented method of claim 1, further comprising:
applying, by the device, a training model that has been applied to the existing virtual dataset to the grouped dataset.

4. The computer-implemented method of claim 2, further comprising:
generating, by the device, a training model for the new virtual dataset with an automatic machine learning algorithm.

5. The computer-implemented method of claim 1, further comprising:
determining, by the device, similarity between the result of the testing and the existing result of running the one or more probe training models on the existing virtual dataset; and
in response to the similarity being larger than a threshold, determining, by the device, the result of the testing being similar to the existing result of running the one or more probe training models on the existing virtual dataset.

6. The computer-implemented method of claim 5, wherein the determining is performed based on at least one of the following:
the Euclidean distance between the result of the testing and the existing result of running the one or more probe training models on the existing virtual dataset;
the Cosine similarity between the result of the testing and the existing result of running the one or more probe training models on the existing virtual dataset; or
the probabilities for each existing result of running the one or more probe training models on the existing virtual dataset being the most similar existing result to the result of the testing.

7. The computer-implemented method of claim 1, wherein the one or more probe training models are generated based on one of the following:
an algorithm of random search; or
manually configuration before the training.

8. The computer-implemented method of claim 1, further comprising:
dynamically splitting, by the device, the existing virtual dataset with other existing virtual datasets;
re-merging, by the device, the split existing virtual dataset and other existing virtual datasets.

9. The computer-implemented method of claim 1, wherein the existing virtual dataset comprises different sub-datasets that belong to different data categories.

10. The computer-implemented method of claim 1, wherein the result of the testing being similar to the existing result of running the one or more probe training models on the existing virtual dataset comprises: each result of the testing based on each of the one or more probe models being similar to each existing result of running the corresponding one or more probe training models on the existing virtual dataset.

11. A system, comprising:
a memory that stores computer executable components;
a processor that executes the computer executable components stored in the memory, wherein the computer executable components comprise:
at least one computer-executable component that:
receives a user dataset for training;
tests the user dataset with one or more probe training models; and
in response that a result of the testing being similar to an existing result of running the one or more probe training models on an existing virtual dataset, groups the user dataset with the existing virtual dataset.

12. The system of claim 11, wherein the at least one computer-executable component also:
in response that the result of the testing not being similar to any existing result of running the one or more probe training models on the existing virtual dataset, sets the user dataset as a new virtual dataset.

13. The system of claim 11, wherein the at least one computer-executable component also:
applies a training model that has been applied to the existing virtual dataset to the grouped dataset.

14. The system of claim 12, wherein the at least one computer-executable component also:
generates a training model for the new virtual dataset with an automatic machine learning algorithm.

15. The system of claim 11, wherein the at least one computer-executable component also:
determines similarity between the result of the testing and the existing result of running the one or more probe training models on the existing virtual dataset; and
in response to the similarity being larger than a threshold, determines the result of the testing being similar to the existing result of running the one or more probe training models on the existing virtual dataset.

16. The system of claim 15, wherein the determining is performed based on at least one of the following:
the Euclidean distance between the result of the testing and the existing result of running the one or more probe training models on the existing virtual dataset;
the Cosine similarity between the result of the testing and the existing result of running the one or more probe training models on the existing virtual dataset; or
the probabilities for each existing result of running the one or more probe training models on an existing virtual dataset being the most similar existing result to the result of the testing.

17. The system of claim 11, wherein the one or more probe training models are generated based on one of the following:
an algorithm of random search; or
manually configuration before the training.

18. The system of claim 11, wherein the at least one computer-executable component also:
dynamically splits the existing virtual dataset with other existing virtual datasets;
re-merges the split existing virtual dataset and other existing virtual datasets.

19. The system of claim 11, wherein the existing virtual dataset comprises different sub-datasets that belong to different data categories.

20. A computer program product facilitating generation of a training model using virtual dataset and probe training models, the computer program product comprising a computer readable storage medium having program instructions embodied therewith, the program instructions executable by a processor to cause the processor to:
receive a user dataset for training;
test the user dataset with one or more probe training models; and
in response to a result of the testing being similar to an existing result of running the one or more probe training models on an existing virtual dataset, group the user dataset with the existing virtual dataset.
